(19) United States
(12) Patent Application Publication
(10) Pub. No.: US 2016/0313711 A1
(43) Pub. Date: Oct. 27, 2016

(54) ENHANCING BASE LOAD OPERATION OF A POWER SYSTEM

(71) Applicants: Israel Hernandez Flores, Queretaro (MX); Juan Palomino Vega, Queretaro (MX)

(72) Inventors: Israel Hernandez Flores, Queretaro (MX); Juan Palomino Vega, Queretaro (MX)

(21) Appl. No.: 14/695,818

(22) Filed: Apr. 24, 2015

(51) Int. Cl. G05B 19/042

(52) U.S. Cl. CPC G05B 19/042; G05B 2219/2639

(57) ABSTRACT

Systems and methods for enhancing base load operation of a power system are provided. According to one embodiment of the disclosure, a method may include receiving a power production request for the power system by at least one processor. The method may also include receiving base load requirements associated with the power system. Based at least in part on the power production request, a firing temperature of the power system is modified to enhance power output of the power system while operating the power system within the base load requirements.

### TECHNICAL FIELD

This disclosure relates generally to power plants and, more particularly, to enhancing base load operation of power plant.

### BACKGROUND

Load in a power plant may vary depending on the demand for electrical power. During the nighttime, electricity demand may be low and, therefore, the power plant may operate at minimum load conditions, while in the daytime, the demand increases and the power system may operate at full load. The unvarying load conditions occurring throughout the day at the power plant may be referred to as the base load. Various power demands of the load above the base load may be referred to as peak loads.

At the base load, the power plant may operate using the rated temperature control setpoint, the setpoint at which the turbine can be operated without sacrificing its life expectancy. The peak load is the load that can be reached at the peak exhaust temperature control setpoint (above the base load setpoint), which may produce more power but reduces the life expectancy of power plant components. It may be undesirable for a power plant to be operated at the peak load, because it may cause wear and tear on power components. However, increased demand during certain time periods may require increased power generation.

### BRIEF DESCRIPTION OF THE DISCLOSURE

The disclosure relates to systems and methods for enhancing base load operation of a power system. According to one embodiment of the disclosure, a system is provided. The system may include at least one controller and at least one computer processor communicatively coupled to the controller. The computer processor may be configured to receive a power production request. The power production request can include a target output of the power system. The target output can be provided via a human module interface by, for example, an operator. The power system may operate at the target output for a period of time under an enhanced base load. The computer processor may be further configured to receive base load requirements associated with the power system. The power system may include a combined cycle power plant, including at least one gas turbine and at least one steam turbine. The steam turbine can extract energy from an exhaust heat generated by the gas turbine. The amount of the extracted energy can be based at least in part on the firing temperature of the power system. The base load requirements can correlate to a hardware life capability of the power system, a maintenance activities schedule of the power system, or emissions of the power system. The computer processor may be further configured to modify a firing temperature of the power system to enhance power output of the power system while operating the power system within the base load requirements. The firing temperature may include a reaction zone temperature in a combustor and may be modified by changing an air to fuel ratio of the gas turbine.

In another embodiment of the disclosure, a method is provided. The method may include receiving a power production request associated with the power system by a computer processor. The method may also include receiving base load requirements associated with the power system. Additionally, operational data of the power system, a hardware life capability of the power system, a temperature rise reference, and a maintenance activities schedule of the power system may be received. Based at least in part on the hardware life capability and the maintenance activities schedule, a maximum firing temperature for a base load state may be determined. The method may also comprise calculating a modifying command to modify the firing temperature of the power system based at least in part on the maximum firing temperature, the power production request, the base load requirements, the operational data, the hardware life capability of the power system, the temperature rise reference, and the maintenance activities schedule of the power system. Based at least in part on the modifying command, the firing temperature of the power system may be modified to enhance power output of the power system while operating the power system within the base load requirements. The modifying may include gradually increasing the load by varying the firing temperature of the gas turbine through the modifying command until the firing temperature is between a base load temperature and a full firing temperature.

In yet another embodiment of the disclosure, a combined cycle power plant is provided. The combined cycle power plant may include at least one gas turbine, at least one steam turbine, at least one controller in communication with the gas turbine and the steam turbine, and at least one processor in communication with the controller. The processor may be configured to receive a power production request to enhance power output of the combined cycle power plant. Additionally, the processor may be configured to receive base load requirements associated with the at least one gas turbine and the at least one steam turbine, and to modify a firing temperature of the power system to enhance power output of the at least one gas turbine and the at least one steam turbine according to the power production request while operating the at least one gas turbine and the at least one steam turbine within the base load requirements.

Other embodiments and aspects of the disclosure will become apparent from the following description taken in conjunction with the following drawings.

### BRIEF DESCRIPTION OF THE DRAWINGS

FIG. 1 is a block diagram illustrating an example environment and system for enhancing a base load operation of a power system, in accordance with some embodiments of the disclosure.

FIG. 2 is a block diagram illustrating operation of a combined cycle power plant, in accordance with some example embodiments of the disclosure.

FIG. 3 depicts a process flow diagram illustrating an example method for enhancing a base load operation of a power system, in accordance with some example embodiments of the disclosure.

FIG. 4 is a graph illustrating power output dependencies of an ambient temperature, in accordance with some example embodiments of the disclosure.

FIG. 5 is a table showing numerical values of power plant estimated performance depending on an ambient temperature and a firing temperature, in accordance with some example embodiments of the disclosure.

FIG. 6 is a block diagram illustrating an example controller for controlling a power system, in accordance with some example embodiments of the disclosure.

### DETAILED DESCRIPTION

The following detailed description includes references to the accompanying drawings, which form part of the detailed description. The drawings depict illustrations, in accordance with example embodiments of the disclosure. These example embodiments of the disclosure, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

Modern manufacturing processes can provide for certain improvements in quality and durability of hardware components of a power plant (e.g., combustion chamber components, gas turbine nozzles, buckets, and so forth). Thus, the hardware components of the power plant may have the ability to operate without any repairs for longer periods of time. Additionally, materials used in the hardware components may allow operation at a relatively higher firing temperature without a corresponding increase in maintenance.

Certain embodiments of the disclosure described herein relate to methods and systems for enhancing the base load operation of a power system. Specifically, a system for enhancing base load operation of a power plant may enable increasing power output while staying within base load operation conditions. Although, in conventional systems, instantaneous load changes may not be possible without violating operating limits set for the base load when operating under the base load conditions, the described embodiment of the disclosure may provide two different methods for enhancing base load operations.

Upon a power production request from an operator, a firing temperature of the power system may be increased. The increase of the firing temperature may be performed without exceeding the base load setpoint established for the power system. By keeping the base load within predetermined limits, installed components of the power plant, especially the combustion parts of a gas turbine of the power plant, may continue operating at recommended maintenance intervals. Thus, certain embodiments of the example system can allow increasing power output without exceeding the base load limits and, thereby, keeping maintenance and inspection schedules at recommended intervals. Furthermore, certain embodiments of the described system may allow increasing output to meet increased short-term power demands. The increase in the power system output may be determined on a case by case basis depending on a unit configuration, an extent of increase in the current base load firing temperature of the power plant, and a selected operating mode. The increased output can be limited to load equipment capabilities.

The technical effects of certain embodiments of the disclosure may include providing an increased power output of a power plant without exceeding base load limits, and correspondingly, maintaining hardware inspection schedules at recommended maintenance intervals, specifically, hardware inspection schedules related to a combustion section of the gas turbine. Further technical effects of certain embodiments of the disclosure may include providing two different methods for selecting a base load. Moreover, the technical effects of certain embodiments of the disclosure may include keeping an exhaust of the power plant within predefined emissions limits.

The following provides the detailed description of various example embodiments of the disclosure related to systems and methods for enhancing base load operation of a power system. The present disclosure is provided with reference to a combined cycle power plant. However, certain embodiments of the systems and methods for enhancing base load operation of a power system may also be applied to other configurations of power systems.

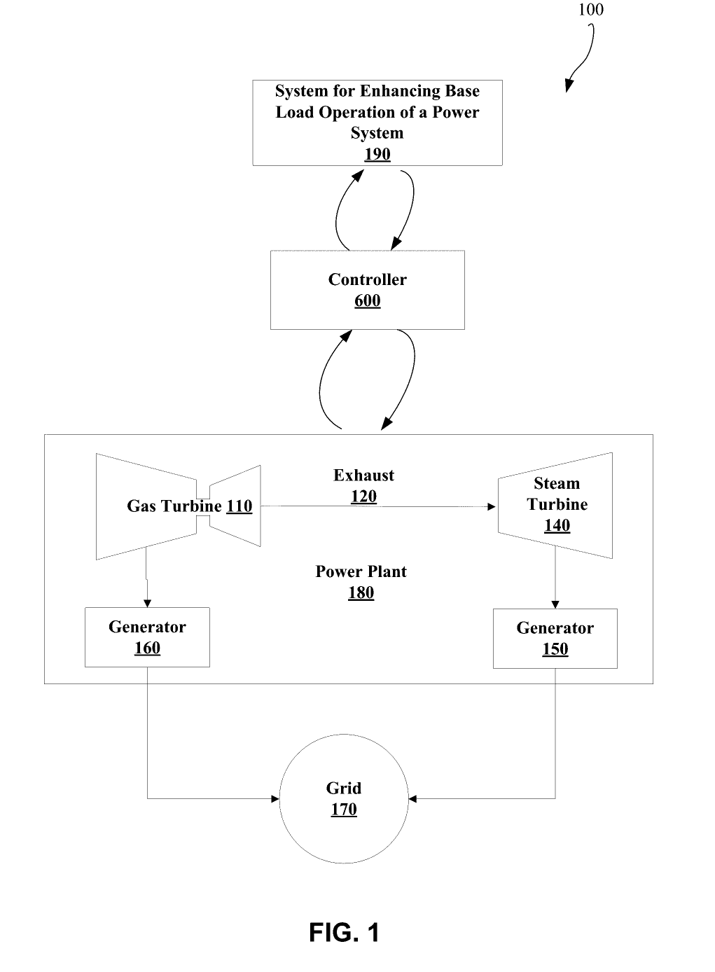

Referring now to FIG. 1, a block diagram illustrates an example system environment 100 suitable for implementing systems and methods for enhancing base load operations of a power plant 180, in accordance with one or more example embodiments of the disclosure. The power plant 180 may include a combined cycle power plant. The power plant 180 may include a gas turbine 110, which produces mechanical power and exhaust energy 120. The exhaust energy 120 may be used to convert water to steam. The produced steam may be used by the steam turbine 140 to produce additional mechanical power. To convert the mechanical power into electrical power, the gas turbine 110 can be mechanically coupled to a generator 160, and the steam turbine 140 can be mechanically coupled to a generator 150. The generators 150 and 160 may be coupled to a grid 170 and provide a supply of electricity to the grid 170. The grid 170 may include various conventional distribution systems.

Thus, the components of the power plant 180 may include at least a gas turbine 110, a steam turbine 140, a generator 150 and 160, a condenser, a superheater, an evaporator, a drum, an economizer, a reheater, a valve, a controller, a pipe, a pump, a pre-heater, a fuel heater, a flow splitter, a flow mixer, an attemperator, a duct burner, a selective catalytic reduction unit, a steam condenser, a condenser hot well, and so forth.

A configuration of the power plant 180 illustrated by FIG. 1 is just one of any number of possible configurations. Other configurations of power systems can be used including those with a gas turbine only, two gas turbines providing exhaust energy to two heat recovery steam generators that in turn feed a single steam turbine to provide combined power, and so forth.

The operation of the power plant 180 may be managed through a controller 600. The controller 600 may interact with the system 190 for enhancing base load operation of a power plant. The system 190 for enhancing base load operation of a power plant may enhance the base load operation firing temperature to a specified level based at least in part on the gas turbine hardware and combustion system configuration. Increasing a firing temperature can be achieved by increasing fuel flow to the gas turbine 110, which in turn increases the reaction zone temperature in the combustor. To obtain an increase in fuel flow, an operating schedule (exhaust temperature control curve) in the controller 600 system can be modified to reflect the changes.

The system 190 can utilize at least two methods for initiating the base load enhancing mode. The first method may utilize a simple pushbutton to ramp the unit to a maximum estimated base load firing temperature (e.g., 2455 F). The second method may utilize a procedure built into the megawatt set point control function. This procedure may provide an operator with flexibility to adjust the firing temperature increase, such that the firing temperature of the power plant 180 remains between the base load and maximum estimated base load levels.

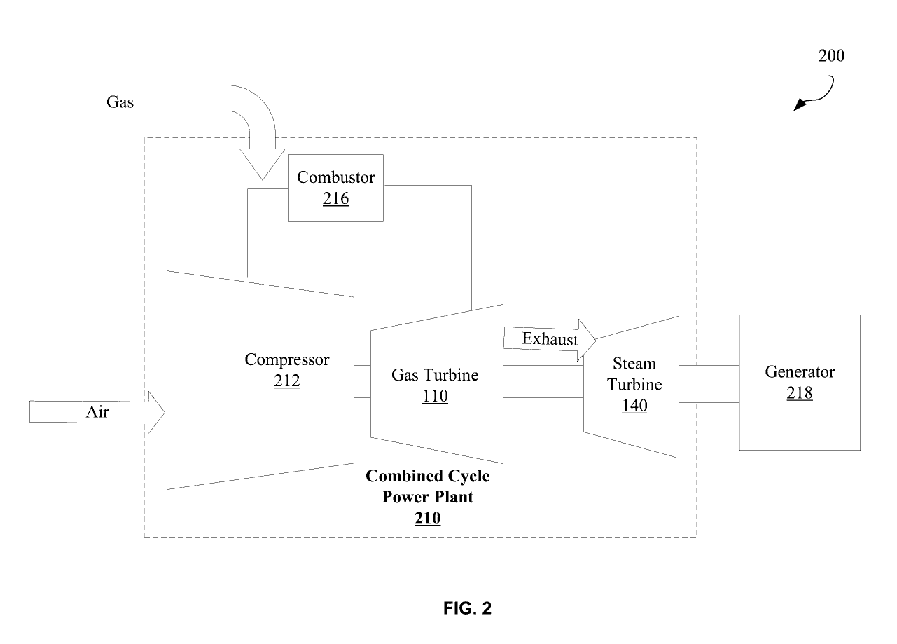

FIG. 2 is a block diagram illustrating operation 200 of a combined cycle power plant 210, in accordance with one or more example embodiments of the disclosure. According to the example embodiment of the disclosure, air flow may enter a compressor 212 in which the air is to be compressed. Gas may be injected into and ignited in a combustor 216 in order to generate a high-temperature flow. The high-temperature and high-pressure flow may enter a gas turbine 110, where it can produce a shaft work output. Exhaust from the gas turbine 110 may be used to heat the water so that the water can be converted into steam. The steam can be directed to a steam turbine 140, which further contributes to power generation of a generator 218.

Using the system for enhancing base load operation of a power system, a firing temperature of the gas turbine 110 may be increased within the base load limits. Subsequently, exhaust temperature of the gas turbine 110 may be also increased. Due to the increase of the exhaust temperature, the amount of steam produced by the exhaust may increase as well. Correspondingly, power output of the steam turbine 140 may increase. Thus, the collective generation of power by the combined cycle power plant 210 may increase due to the increase in the firing temperature, while the combined cycle power plant 210 remains within the base load limits.

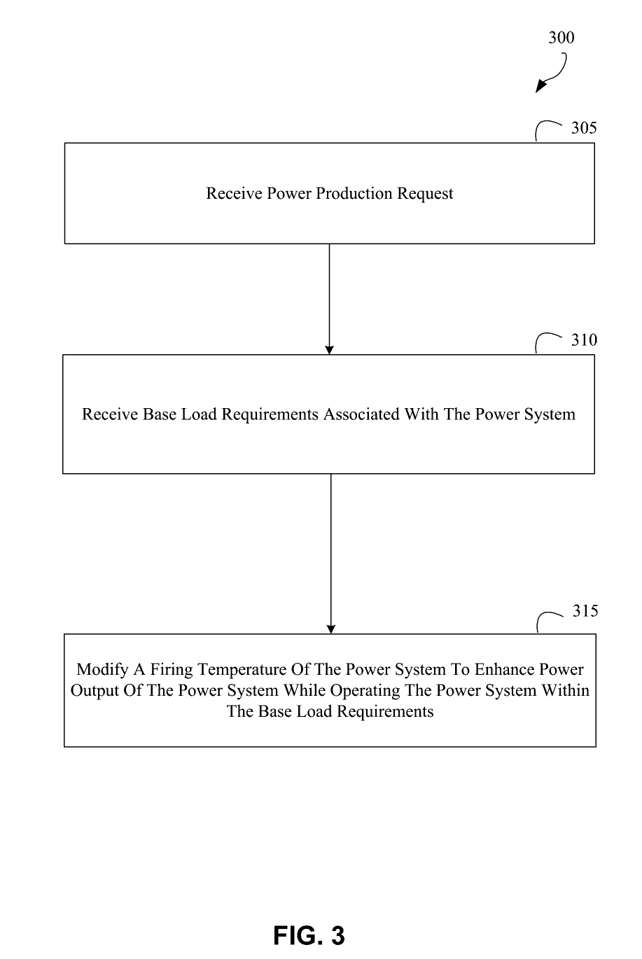

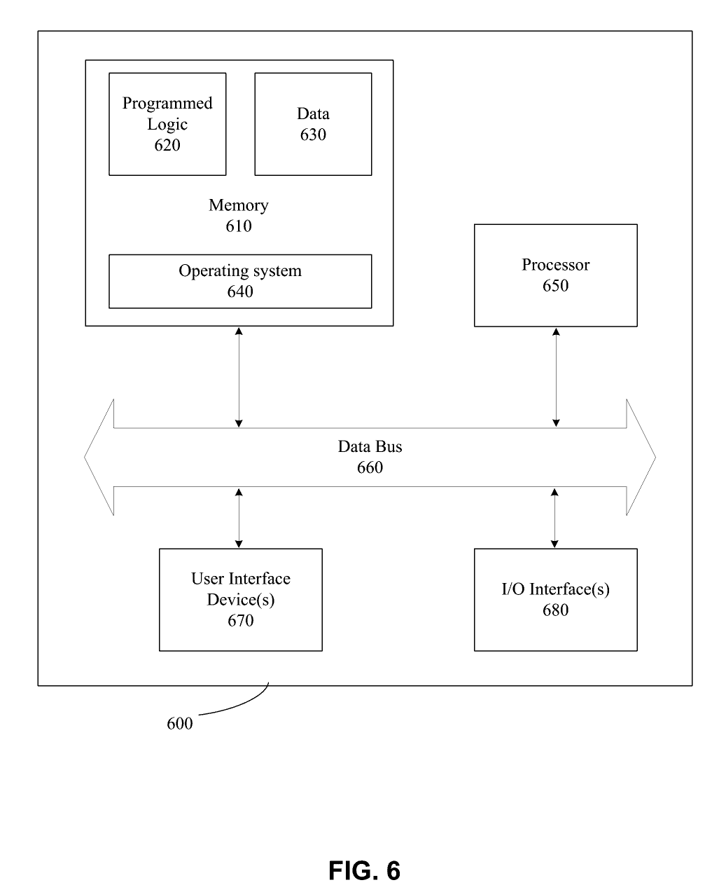

FIG. 3 depicts a process flow diagram illustrating an example method 300 for enhancing base load operation of a power plant, in accordance with an embodiment of the disclosure. The method 300 may be performed by processing logic that may comprise hardware (e.g., dedicated logic, programmable logic, and microcode), software (such as software run on a general-purpose computer system or a dedicated machine), or a combination of both. In one example embodiment of the disclosure, the processing logic resides at the controller 600 shown in FIG. 6, which may itself reside in a user device or in a server. The controller 600 may comprise processing logic. It will be appreciated by one of ordinary skill in the art that instructions said to be executed by the controller 600 may, in fact, be retrieved and executed by one or more processors. The controller 600 may also include memory cards, servers, and/or computer disks. Although the controller 600 may be configured to perform one or more steps described herein, other control units may be utilized while still falling within the scope of various embodiments of the disclosure.

As shown in FIG. 3, the method 300 may commence at operation 305 with receiving a power production request. The power production request may include a target output of the power system. The power production request may be received via a human module interface from an operator of the power system if an increase in the power generation is desired. The power system may include a gas power plant, a steam power plant, a combined cycle power plant, and so forth. The components of the power system may include a gas turbine, a steam turbine, a generator, a condenser, a superheater, an evaporator, a drum, an economizer, a reheater, a valve, a controller, and so forth. In case of a combined power plant including at least one gas turbine and at least one steam turbine, an amount of energy extracted by the steam turbine from an exhaust heat generated by the gas turbine may be based at least in part on the firing temperature of the power system.

At operation 310, base load requirements associated with the power system may be received. The base load requirements may be received from the controller, which stores the base load requirements or receives the base load requirements from other sources. Additionally, operational data associated with the power system, a hardware life capability of the power system, a temperature rise reference, a maintenance activities schedule of the power system, and other data may be received.

It should be noted that a firing temperature includes a parameter that is conventionally used to limit the power output of gas turbines. However, the existing instrumentation may not allow to reliably measure the reaction temperature in the combustor discharge duct or a turbine inlet section. Therefore, the firing temperature of the gas turbine may be estimated based at least in part on turbine parameters, e.g., an exhaust gas temperature, a compressor discharge temperature and pressure, and so forth.

The base load requirements may be correlated to the hardware life capability, maintenance activities schedule, emissions, and so forth. In some embodiments of the disclosure, a maximum firing temperature for the components of the gas turbine (e.g., components of the combustor) in a base load state may be estimated based at least in part on the hardware life capability and the maintenance activities schedule. The maximum firing temperature may be compared to the base load requirements. For example, the base load requirements may include 24/20 firing degrees for hardware components, while the maximum firing temperature as estimated may be 24/55 degrees. Thus, it may be estimated that the firing temperature may be increased in the 24/55 degrees range without causing deterioration of hardware components of the power system.

Furthermore, a modifying command to change the firing temperature of the power system in order to reach the target output may be calculated. The calculation may consider the maximum firing temperature, the base load requirements, the operational data, the hardware life capability of the power system, the temperature rise reference, the maintenance activities schedule of the power system, and so forth. The modifying command may determine an amount of fuel to be injected into the combustor in order to increase the firing temperature. For calculation of a function of the ambient temperature, the fuel to air radio may be applied. Through the increase in the firing temperature, the exhaust temperature may be modulated, and the power output may correspond to the target output.

At operation 315, the firing temperature of the power system may be modified to enhance power output of the power system using the modifying command. The firing temperature may include a reaction zone temperature in a combustor. The firing temperature may be modified by changing an air to fuel ratio injected in the combustor. This may be done through controlling at least one fuel inlet to increase fuel flow entering the gas turbine.

In some embodiments of the disclosure, the modifying of the firing temperature is performed gradually. The firing temperature may be varied by escalating steps of 5-10 degrees, while the firing temperature is between a base load temperature and a full firing temperature. The resulting output may increase gradually in a similar manner. The operator can select a base load mode using two different approaches. The first approach may include pushing a button to ramp the power system in order to enhance the base load. The second approach may include a procedure built into the megawatt setpoint control function.

For example, if the power system output is set to 172 megawatts, the operator may choose to increase the output to 180 megawatts. To this effect, the operator may designate 180 megawatts as the target output. The controller may use constants and calculate the modifying command to provide the target output. Alternatively, if the operator desires the power system to operate at an enhanced firing temperature during a certain period of time, the operator can select a variable base load, and the firing temperature may only increase for five firing degrees in order to achieve a desired output.

Modifying the firing temperature may be limited by the based load requirements of the power system. Therefore, the power system may operate at the target output for a period of time under an enhanced base load capability. Because the power system remains within the base load limits, the increased output may be obtained without exceeding allowable emissions levels and without shortening the maintenance intervals.

For example, inspection, maintenance, and repair of parts of a power plant may be required after a certain period of time, for example, 24,000 hours of operation. Numerous factors may affect this period, one of which is operating the power plant at a peak load. The peak load operation may lead to shortening of the maintenance period, for example, to 12,000 hours of operation. However, using the system for enhanced base load operation of the power plant allows increasing power generation without operating at the peak load.

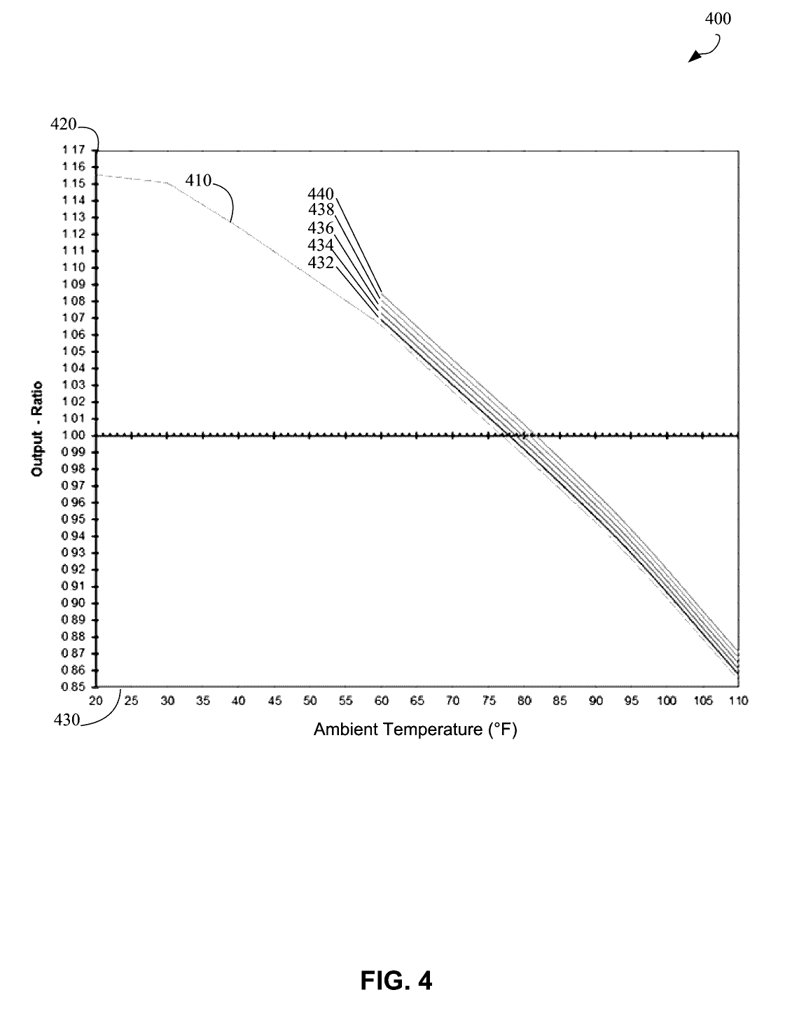

FIG. 4 is a graph 400 illustrating power output dependencies of an ambient temperature, in accordance with one or more example embodiments of the disclosure. The turbine output may vary with changes in operating conditions, specifically, with changes in an ambient temperature of the power system. This dependency may be illustrated by graph 400. An output 420 of the gas turbine is shown as a function of ambient temperature 430. The graph 400 includes several curves demonstrating output 420 dependency on the firing temperature. Curve 410 shows output 420 under a base load firing temperature without any adjustments. Curves 432-440 illustrate a result of a firing temperature increase by 5 degrees. Curve 432 shows a firing temperature increase by 5 degrees, curve 434 shows a firing temperature increase by 10 degrees, and a curve 436 shows a firing temperature increase by 15 degrees. As shown in FIG. 4, the firing temperature increase over the base load level allows achieving an output increase. Thus, increasing the firing temperature within the estimated maximum firing temperature limits enables continued base load operation.

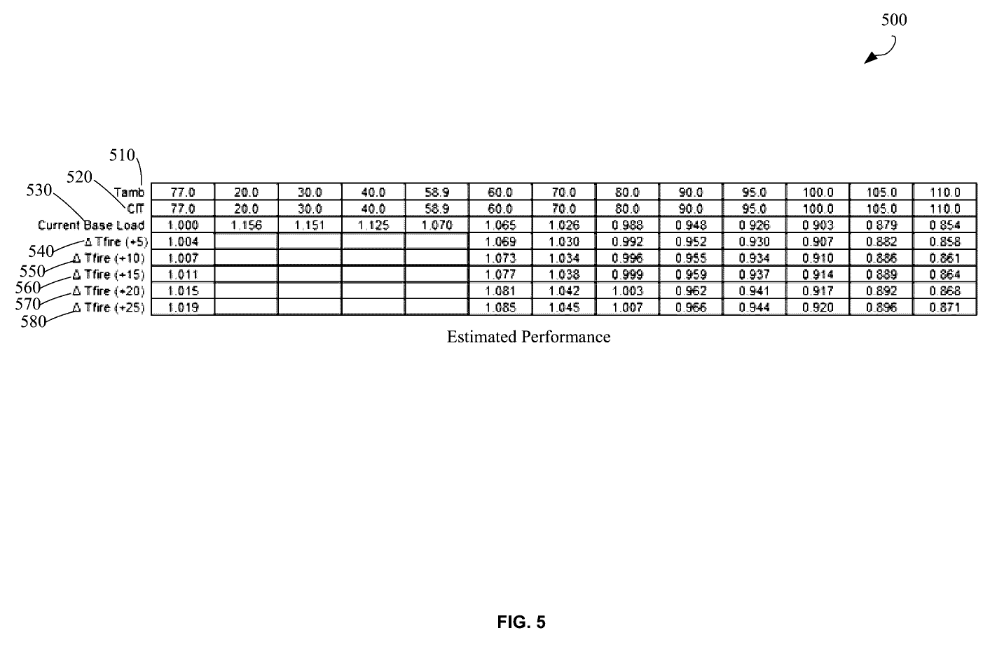

FIG. 5 is a table showing numerical values of a power plant estimated performance depending on an ambient temperature and a firing temperature, in accordance with one or more example embodiments of the disclosure. Table 500 shows output changes of an example power system. Row 510 of table 500 includes values of an ambient temperature of the power system. Row 520 includes compressor inlet temperature values. Row 530 includes power output-ratio values under a current base load operation. Rows 540-580 include output-ratio changes occurring with the firing temperature increase. Specifically, a firing temperature increase by 25 degrees may result in approximately 3.23 megawatt increase in power output.

FIG. 6 depicts a block diagram illustrating an example controller 600 for simulation and enhancement of operations of power plant, in accordance with an embodiment of the disclosure. More specifically, the elements of the controller 600 may be used to simulate and enhance operations of the power plant. The controller 600 may include a memory 610 that stores programmed logic 620 (e.g., software) and may store data 630, such as geometrical data and the operation data of a power plant, a dynamic model, performance metrics, and the like. The memory 610 also may include an operating system 640.

A processor 650 may utilize the operating system 640 to execute the programmed logic 620, and in doing so, may also utilize the data 630. A data bus 660 may provide communication between the memory 610 and the processor 650. Users may interface with the controller 600 via at least one user interface device 670, such as a keyboard, mouse, control panel, or any other devices capable of communicating data to and from the controller 600. The controller 600 may be in communication with the power plant online while operating, as well as in communication with the power plant offline while not operating, via an input/output (I/O) interface 680. More specifically, one or more of the controllers 600 may carry out the execution of the model-based control system, such as, but not limited to, receive geometrical data and operational data associated with components of the power plant, create a dynamic model of the power plant for components based at least in part on the geometrical data and the operation data, generate a surrogate model for a specific performance metric based at least in part on the dynamic model, incorporate the surrogate model into an enhancement procedure, and exercise the enhancement procedure under an enhancement objective to enhance operations of the power plant for the specific performance metric. Additionally, it should be appreciated that other external devices or multiple other power plants may be in communication with the controller 600 via the I/O interface 680. In the illustrated embodiment of the disclosure, the controller 600 may be located remotely with respect to the power plant; however, it may be co-located or even integrated with the power plant. Furthermore, the controller 600 and the programmed logic 620 implemented thereby may include software, hardware, firmware, or any combination thereof. It should also be appreciated that multiple controllers 600 may be used, whereby different features described herein may be executed on one or more different controllers 600.

Accordingly, certain embodiments of the disclosure described herein can allow for constrained, multi-objective simulation and enhancement of operations of a power plant. The multi-objective enhancement may be accomplished through the use of surrogate models in order to satisfy the function call requirements. However, the dynamic simulation of the power plant may also be executed in a time-efficient manner, i.e., on the order of minutes, in order to generate the data to regress. Due to dynamic simulation of the power plant operation, optimal operation of the power plants may be achieved. Additionally, time history of performance metrics within the power plant may be predicted under a variety of operating conditions.

References are made to block diagrams of systems, methods, apparatuses, and computer program products according to example embodiments of the disclosure. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments of the disclosure disclosed and that modifications and other embodiments of the disclosure are intended to be included within the scope of the appended claims. Although specific terms are employed herein, they are used in a generic and descriptive sense only and not for purposes of limitation.

What is claimed is:

1. A system comprising:
at least one controller; and
at least one processor communicatively coupled to the at least one controller and configured to:
receive a power production request;
receive base load requirements associated with a power system; and
modify a firing temperature of the power system to enhance power output of the power system while operating the power system within the base load requirements.

2. The system of claim 1, wherein the power system includes a combined cycle power plant, the combined power plant including at least one gas turbine and at least one steam turbine, an amount of energy extracted by the steam turbine from exhaust heat generated by the gas turbine being based at least in part on the firing temperature of the power system.

3. The system of claim 1, wherein the base load requirements are correlated to at least one of the following:
a hardware life capability of the power system;
a maintenance activities schedule of the power system; and
emissions of the power system.

4. The system of claim 1, wherein the power production request includes a target output of the power system.

5. The system of claim 1, wherein the target output is provided via a human module interface.

6. The system of claim 1, wherein the power system is configured to operate at the target output for a period of time under an enhanced base load.

7. The system of claim 1, wherein the power production request includes enhancing the power output using a steady state base load.

8. The system of claim 1, wherein the firing temperature is modified by changing an air to fuel ratio.

9. The system of claim 1, wherein the firing temperature includes a temperature of a reaction zone of a combustor.

10. A method for enhancing base load operation of a power system, the method comprising:
receiving, by at least one processor, a power production request;
receiving, by at least one processor, base load requirements associated with the power system; and
modifying, by at least one processor, a firing temperature of the power system to enhance power output of the power system while operating the power system within the base load requirements.

11. The method of claim 10, further comprising receiving, by at least one processor, operational data associated with the power system.

12. The method of claim 11, further comprising receiving, by at least one processor, a hardware life capability of the power system, a temperature rise reference, and a maintenance activities schedule of the power system.

13. The method of claim 12, further comprising determining a maximum firing temperature in a base load state based at least in part on the hardware life capability and the maintenance activities schedule.

14. The method of claim 13, further comprising calculating, by at least one processor, a modifying command to modify the firing temperature of the power system based at least in part on at least one of the following: the maximum firing temperature, a power production request, the base load requirements, the operational data, the hardware life capability of the power system, the temperature rise reference, and the maintenance activities schedule of the power system.

15. The method of claim 14, wherein the modifying includes gradually increasing the load by varying the firing temperature of at least one gas turbine through the modifying command until the firing temperature is between a base load temperature and a full firing temperature.

16. The method of claim 10, wherein the modifying includes controlling at least one fuel inlet to increase fuel flow entering at least one gas turbine.

17. The method of claim 10, wherein the modifying includes modulating an air-to-fuel ratio of at least one gas turbine.

18. The method of claim 10, wherein the modifying the firing temperature is operable to increase an output of at least one gas turbine associated with the power system.

19. The method of claim 10, further comprising correlating the base load requirements to at least one of the following: the hardware life capability of the power system, the maintenance activities schedule of the power system, and emissions of the power system.

20. A combined cycle power plant comprising:
at least one gas turbine;
at least one steam turbine;
at least one controller in communication with the gas turbine and the steam turbine; and
at least one processor in communication with the at least one controller and configured to:
receive a power production request;
receive base load requirements associated with the at least one gas turbine and the at least one steam turbine; and
modify a firing temperature of the power system to enhance power output of the at least one gas turbine and the at least one steam turbine while operating the at least one gas turbine and the at least one steam turbine within the base load requirements.
